(19) United States
(12) Patent Application Publication
(10) Pub. No.: US 2015/0007233 A1
(43) Pub. Date: Jan. 1, 2015

(54) INTEGRATED CABLE AND OVER-THE-TOP VIDEO CONTENT DELIVERY SYSTEM

(71) Applicant: aioTV, Inc., Centennial, CO (US)

(72) Inventor: Michael Everett Earle, Centennial, CO (US)

(73) Assignee: aioTV, Inc., Centennial, CO (US)

(21) Appl. No.: 14/218,272

(22) Filed: Mar. 18, 2014

Related U.S. Application Data
(63) Continuation of application No. 13/973,887, filed on Aug. 22, 2013.
(60) Provisional application No. 61/839,482, filed on Jun. 26, 2013.

(51) Int. Cl. H04N 21/462; H04N 21/61; H04N 21/2665; H04N 21/4782; H04N 21/472; H04N 21/482

(52) U.S. Cl. CPC H04N 21/4622; H04N 21/47202; H04N 21/4821; H04N 21/2665; H04N 21/4782; H04N 21/6125; H04N 21/6175
USPC 725/44; 725/49

(57) ABSTRACT

A media player pass-through device is used to provide an integrated programming guide and content from both cable television services and a variety of over-the-top (OTT) video content sources. Based on data received from the cable provider, the programming guide may include video corresponding to a cable television video signal, and a menu of available channels and OTT video content sources.

### RELATED APPLICATIONS AND CLAIM OF PRIORITY

This patent application claims priority to and is a continuation of U.S. patent application Ser. No. 13/973,887, titled “Integrated Cable and Over-the-Top Video Content Delivery System,” filed Aug. 22, 2013. This patent application also claims priority to U.S. Provisional Patent Application No. 61/839,482, filed Jun. 26, 2013.

This patent document is also related to U.S. patent application Ser. No. 13/973,902, titled “Method and System for Delivering Video Content from Multiple Platforms to Subscribers;” and U.S. patent application Ser. No. 13/973,915, titled “Method and System for Creating Video Channels for Delivery of Content from Multiple Platforms;” each of which was filed on Aug. 22, 2013.

This patent document is also related to U.S. patent application Ser. No. ______, titled “Method and System for Delivering Video Content from Multiple Platforms to Subscribers” (attorney docket 114317.00211); and U.S. patent application Ser. No. ______, titled “Method and System for Creating Video Channels for Delivery of Content from Multiple Platforms” (attorney docket 114317.00311); each of which was filed on the filing date of this application.

The disclosures of each document listed above are fully incorporated herein by reference.

### BACKGROUND

Consumers of video content today have an ever-growing number of content sources available to them. Cable television service providers can provide many broadcast and subscription-based channels. Internet websites and mobile apps provide an almost unlimited variety of additional content, much of which is on-demand. Many internet websites are also subscription based. However, consumers have no ability to easily navigate the vast array of content sources. They may need to use one device for cable service and a second device for Internet sources. Although attempts have been made to integrate multiple services in a single device, those attempts still require the user to switch between inputs and modes of operation of the device. This leads to frustration for consumers and the potential for concern to cable service providers as their customers migrate away from them and toward other, third party content sources.

This document describes a system that addresses the issues described above, and/or additional issues.

### SUMMARY

In an embodiment, a system for providing video content to a subscriber is implemented using a media player device having a first input interface configured to receive a video signal from a cable television service provider, a second input interface configured to provide a connection to a communication network on which videos are available from over-the-top video sources not affiliated with the cable television service provider, an output port configured to deliver the video signal and over-the-top content items from the over-the-top video sources to a display device, a processor, and a computer-readable medium containing programming instructions that, when executed, cause the processor to output a content delivery interface at the display device. The content delivery interface may include a home screen that displays video corresponding to the video signal, along with a menu of applications. A subset of applications will correspond to available over-the-top video content sources. In various embodiments, the system also may include a display device, a cable television service provider set top box, and/or a remote control that is programmed to control the display device and the media player device.

The programming instructions that cause the processor to output the content delivery interface may include instructions to implement the home screen as a unified display so that video corresponding to the video signal is displayed in a background on the display device, while the menu of applications is displayed in a foreground on the display device so that the menu obscures at least a portion of the video being displayed in the background. To prepare the menu of applications, the instructions may cause the processor to send a query and an identifier to the cable television service provider via the communication network. The identifier may be a subscriber identifier, media player identifier, or other authentication token. The cable service provider may use this information to identify and send to the media player a set of menu items that include over-the-top video sources, at least a portion of which are sources for which a user associated with the identifier is a registered user. The processor may then cause the menu to include icons corresponding to the set of menu items. The processor may also cause the menu to include an icon for a unified programming guide that, when selected by the user, will display a menu of a set of cable television channels to which the user subscribes along with a set of over-the-top video sources designated by the cable television service provider.

In some embodiments, the programming instructions may be configured to cause the content delivery interface to present an integrated programming guide screen for the video signal and the content items from over-the-top sources by: (i) receiving, via the first input interface, a first video signal corresponding to a channel to which a cable television service provider set top box is set; (ii) displaying video corresponding to the first video signal in a media player section of the programming guide screen; (iii) receiving, via the second input interface, data corresponding to a set of channels that are included in a package to which a user of the media player device subscribes, where the channels include broadcast channels supplied by the cable television service provider and channels for over-the-top video sources that are not affiliated with the cable television service provider; (iv) displaying at least a subset of the channels in a channel selector portion of the programming guide screen; (v) identifying one of the displayed channels as a featured channel; and (vi) displaying a menu of video content that is available on the featured channel in an asset listing interface on the programming guide screen.

If the featured channel is a cable television channel, the programming instructions that are configured to cause the content delivery interface to present the menu of video content for the featured channel may include instructions to retrieve a list of upcoming programs on the featured channel, and display information corresponding to the upcoming programs in the menu of video content so that the upcoming programs are displayed in chronological order and the displayed information includes a start time for each upcoming program.

If the featured channel corresponds to an over-the-top video source, the programming instructions that are configured to cause the content delivery interface to present the menu of video content for the featured channel may include instructions to: (i) retrieve a list of available video-on-demand programs on the featured channel; (ii) display information corresponding to the available video-on-demand programs in the menu of video content; (iii) receive a user selection of one of the available video-on-demand programs; (iv) extract, from the data received via the second input interface, an address for an over-the-top video service for the user-selected available video program; and (v) cause the display to present the user-selected video-on-demand program as served by the over-the-top video service.

In some embodiments, the media player device also may include an additional output port, and the system may include a transmitter connected to the additional output port. The system also may include additional programming instructions that, when executed, cause the processor to determine when the media player device receives a channel change command from a remote control device, and, in response to the channel change command, generate a signal that, when transmitted via the transmitter to the cable television service provider set top box, will cause the cable television service provider set top box to implement the channel change command so that the video signal thereafter corresponds to a channel associated with the command.

In an alternate embodiment, a media player device includes a processor and a non-transitory computer-readable memory. The media player device may receive, via a first input interface, a video signal from a cable television service provider. The media player device also may receive, via a data communication network through a second interface, data signals from the cable television service provider, and also data signals from over-the-top video sources not affiliated with the cable television service provider. The media player device may send, via an output port, a signal that causes a display device to present a content delivery interface. The content delivery interface may include a unified programming guide screen that displays video corresponding to the video signal in a media player section of the programming guide screen, along with a channel selector containing identifying information for a set of channels. The channels may include broadcast channels supplied by the cable television service provider and channels for over-the-top video sources that are not affiliated with the cable television service provider.

The media player device may identify one of the displayed channels as a featured channel, and it may display a menu of video content that is available on the featured channel in an asset listing interface on the programming guide screen. If the featured channel is a cable television channel, then when causing the content delivery interface to present the menu of video content for the featured channel the system may retrieve a list of upcoming programs on the featured channel. Also, it may display information corresponding to the upcoming programs in the menu of video content, so that the upcoming programs are displayed in chronological order and the displayed information includes a start time for each upcoming program. If the featured channel corresponds to an over-the-top video source, then causing the content delivery interface to present the menu of video content for the featured channel may include: (i) retrieving a list of available video-on-demand programs on the featured channel; (ii) displaying information corresponding to the available video-on-demand programs in the menu of video content; (iii) receiving a user selection of one of the available video-on-demand programs; (iv) extracting, from the data received via the second input interface, an address for an over-the-top video service for the user-selected video-on-demand program; and (v) causing the display to present the user-selected video-on-demand program as served by the over-the-top video service.

### BRIEF DESCRIPTION OF THE DRAWINGS

FIG. 1 illustrates an example of a media player pass-through device, which in this example is a set top box.

FIG. 2 is a block diagram illustrating various components that may be included within a media player device.

FIG. 3 is a block diagram illustrating various components that may be included in or be used with an integrated content delivery system.

FIG. 4 illustrates an example of a home screen for an integrated video content delivery system.

FIG. 5 illustrates an example of a programming guide screen for an integrated video content delivery system.

FIG. 6 illustrates an additional example of a programming guide screen for an integrated video content delivery system.

FIG. 7 is an example of a process flow for a video content delivery system.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

This document describes a system that integrates video content from a cable television service provider and one or more over-the-top sources. This document uses the term “cable television service provider” to refer to a television service provider that distributes multiple broadcast and subscription-based video channels to subscribers. The cable television service provider may supply the channels via radio frequency (RF) signals transmitted through a network of coaxial and/or fiber optic cables, via direct broadcast satellite transmissions, or by other delivery means. Thus, when this document uses the term “cable television service provider,” it is intended to include all such subscription-based providers including traditional cable television providers, satellite television providers and the like.

An “over the top” (OTT) source is a common term used to refer to a source of video content that is not affiliated with the cable television service provider, but the service provider may facilitate access to the OTT source by its subscribers. OTT sources typically provide digital video signals via digital communication networks such as the Internet.

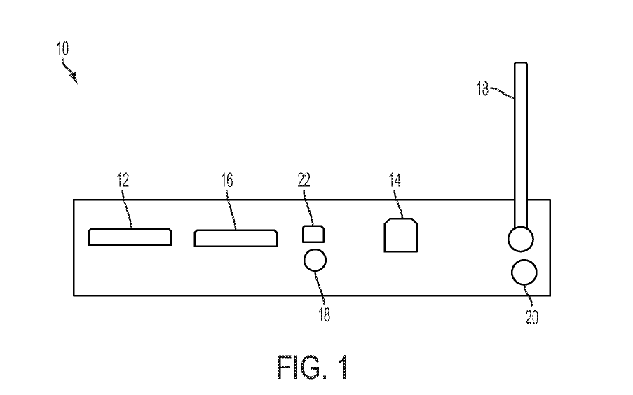

FIG. 1 illustrates an example of a media player pass-through box 10 that may be used in various embodiments. A pass-through box refers to an electronic device that is used to pass digital signals of media content from multiple sources to a display device, optionally with additional processing elements that assist a user in selectively retrieving media assets. Although FIG. 1 illustrates the box 10 as a stand-alone device that may be connected to a television via a wired or wireless connection, elements of the box may be integrated with a television set or display device. Thus, box 10 is an example of a media player device, and both stand-alone and integrated devices are intended to be within the scope of this disclosure.

As shown in FIG. 1, the media player pass-through set top box 10 includes a power input 20 that is used to connect the box 10 to an external power source, and a first input interface 12 configured to receive an analog or digital video signal from a cable television service provider. The first input interface 12 may be a coaxial cable port for receiving an RF or digital signal via a coaxial cable, a universal serial bus (USB) port, an HDMI port (as shown) or another port for receiving a signal from an external source such as the cable television service provider's set top box, or another input device. The media player device 10 also may include any number of second input interfaces configured to receive a digital signal from a communications network, such as an Ethernet port 14, an antenna 18 to receive signals from a wi-fi network or other wireless communication network, or another interface. The first interface 12 will receive content supplied by the cable television service provider, such as broadcast television channels and subscription-based television channels. The second interface 14 will connect with an external digital communications network and will receive OTT content from external sources, such as video content that is available from various websites. Through the external communications network, the second interface 14 also may exchange communications with a data server of the cable television service provider. The communications may include instructions for a programming guide, information about subscription packages to which the device's user has access, identifying information relating to the user, and other information. The media player device 10 may include any number of additional input ports for receiving digital content from additional OTT sources and/or external memory devices that are connected to the additional ports.

The pass-through box 10 may also include an output port 16 configured to deliver the video from the input ports to an external display, such as a high definition multimedia interface (HDMI) port to a television. Alternatively, the device's output ports may provide connections to an integrated display, which may occur when the device is integrated within a television set. The device 10 may include additional output ports, such as an audio output port 22. In addition, the device 10 may include a short-range transmission output port 18, such as an infrared (IR) port to which an IR blaster (transmitter) may be connected. The device 10 may include or be in communication with a storage medium on which any suitable operating system and programming is installed, such as an Android or Linux-based operating system and an XBMC media player application.

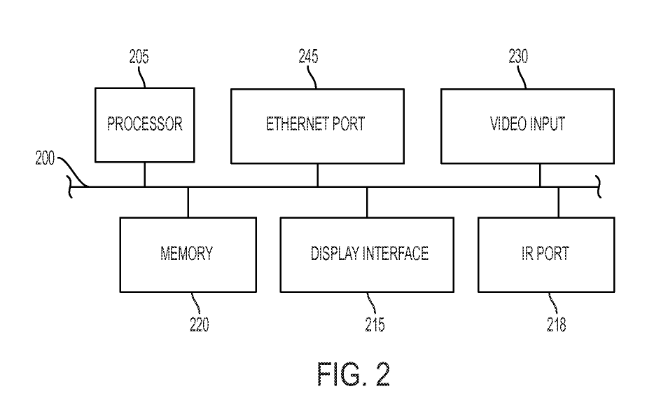

FIG. 2 illustrates various components that may be included within a media player device. The device may include the various ports/interfaces described above, such as a video input 230 that serves as the first interface to the cable television service provider source, an Ethernet port 245 that serves as the second interface to the OTT content and to an external server of the cable service provider, an IR port 218 that delivers IR signals to an external transmitter, and a display interface port 215 that operates to send the video to a connected display device. The device may include a processor 205 and non-transitory computer-readable medium 220 such as random access memory (RAM) and/or read-only memory (ROM). When this disclosure and its claims use the terms “processor” and “memory” or “computer-readable medium,” unless the context specifically indicates otherwise the intent is to cover both single device embodiments and multiple device embodiments (such as two or more processors that together perform various steps of a method.) One or more data busses 200 may serve as an information channel to deliver signals between the various components.

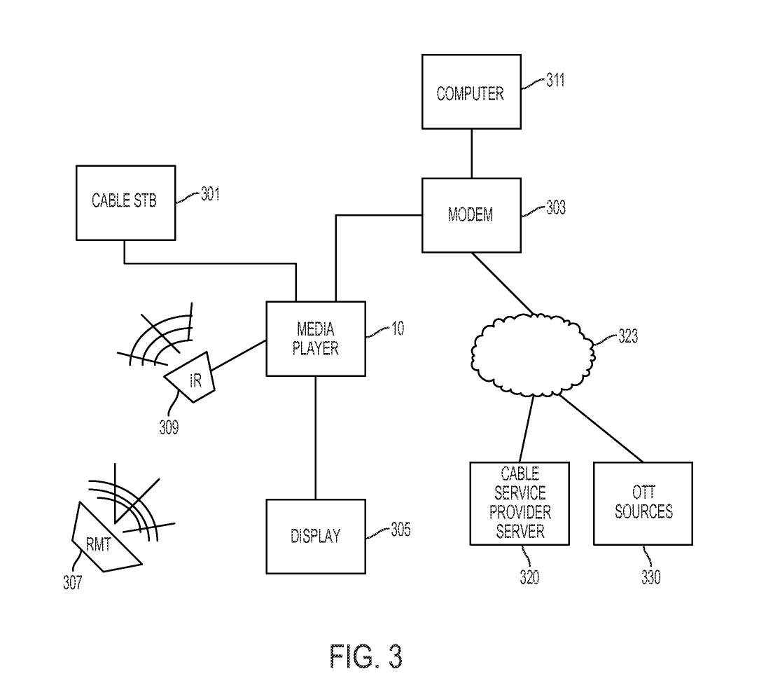

FIG. 3 illustrates an example of various components of a system for integrating cable and OTT content. The system may include a media player pass-through device 10 as described above. The media player device 10 may be in electronic communication with a cable service provider video source such as a digital video recorder or other set top box 301. The media player device 10 also may be in electronic communication with a digital communications network 323 via a modem 303 or equivalent communications interface. The media player device 10 also may be in electronic communication with a display device 305, such as a television, so that the media player device 10 can deliver video content to the display device 305. Any or all of the electronic communication mechanisms described above may be a wired connection or a wireless connection such as a wi-fi or other short range or near field communications network.

A remote control 307 may be available so that a user can control any or all of the components of the system. For example, the remote control 307 may be programmed to operate the cable service provider set top box 301, the television or other display 305, and/or a computing device 311 that is connected to the modem 303. Alternatively or in addition, the media player device 10 may be connected to an external transmitter 309 that delivers signals to the cable service provider set top box 301. For example, if the media player device 10 includes an IR port, then the transmitter 309 may be an IR blaster that may send signals from the media player device 10 to the cable service provider set top box 301. The signals may include commands such as commands to cause the cable service provider set top box to change a channel, to generate a menu of available stored or live content, or other commands.

The media player pass-through device 10 also may be in electronic communication with a cable service provider data server 320 through one or more communications networks 323 such as the Internet and/or a cable television service provider network. The media player pass-through device 10 also may be in electronic communication any number of OTT content sources 330 through the communications network 323.

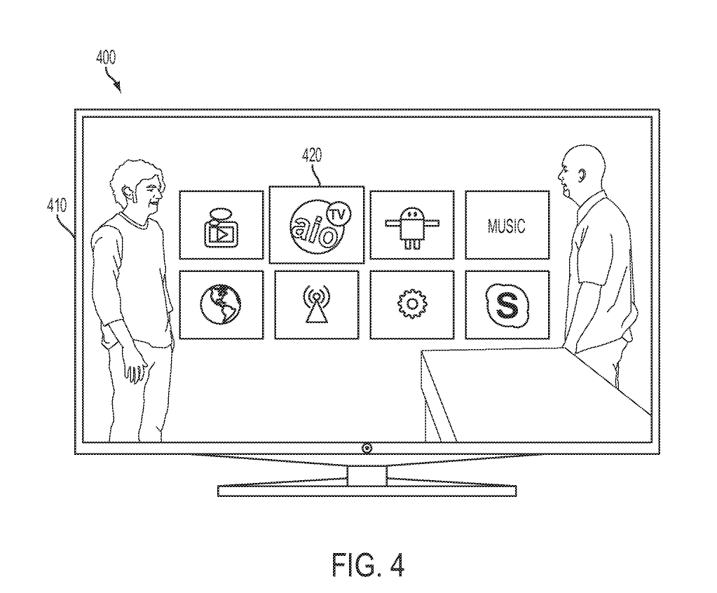

FIG. 4 illustrates an example of a home screen 400 that may be served to a display via an integrated video content delivery system such as that described above. The home screen includes a background portion 410 and a foreground portion 420 that obscures at least a portion of the background portion. The background portion displays a feed of a broadcast or subscription-based channel from the cable television service provider. The feed displayed in the background may correspond to the channel to which the cable service provider set top box (element 301 in FIG. 3) is set, or it may be a default channel such as a designated “home” channel that is used in a closed circuit system such as a hotel or entertainment venue. The media player device may be programmed to process the background feed so that it is displayed in low brightness or other muted format that is not as clear or as bright as the original feed.

The foreground portion 420 of the home screen displays a menu of user-selectable inputs, at least some of which are for OTT programming sources. The OTT sources may be presented as app icons, as shown, with various app icons corresponding to an Internet Protocol (IP) address of a website, or to a software application (sometimes referred to as an app) installed on the media player device. At least some of the apps will be associated with third party content available via an IP address. The available apps may include OTT service apps that include addresses for and/or which facilitate access various sites where video content is available, such as social media apps (e.g., Facebook, Vine or Instagram), video sharing apps (e.g., YouTube and/or apps for broadcast network sites such as NBC.com and ABC.com), and subscription-based video content delivery apps (e.g., Netflix or Hulu). The icons or other channel representations included in the user-selectable menu may correspond to a package of content to which the user has purchased a subscription from the cable service provider, to one or more OTT content sources or cable channels that the user has designated as being a favorite channel, and/or to one or more cable channels or OTT sources that the cable service provider desires to promote to the user. In addition, at least one of the user-selectable inputs may be an app that, when selected, launches a programming guide screen rather than an external source. An example programming guide screen will be discussed below. When the user turns on the display and/or media player pass through device, the programming on the media player device may retrieve the content menu from the cable service provider via the communications network and display it in the foreground or otherwise to the user.

As shown, the foreground portion 420 obscures at least a portion of the background portion 410 by covering the background portion. Optionally, the foreground portion 420 may cover only part of the display, or (as shown) it may cover all of the display but include a partially transparent overlay in areas that do not contain user-selectable input icons. In this way, the foreground portion 420 may obscure and hide the background 410 in locations where the input icons appear, but it may merely mute the brightness of, decrease the sharpness of, or otherwise alter the background 410 but continue to show the background in areas where no icons appear.

The media player device may include programming that, when executed, causes the device to prepare and present the home screen as described above. This programming may be, for example, a launcher application that implements a rule set to retrieve the menu of user-selectable icons from the cable service provider server and present them on the home screen. The rule set may include a rule to always display one or more default icons such as a programming guide icon or an icon for one or more preferred sources. The rule set also may include rules configured to prompt the display of one or more icons that correspond to user-selected settings. Examples include icons for apps that the user of the media player box wants to integrate with the cable service; icons corresponding to channels, packages or other services to which the user subscribes; or icons corresponding to apps, channels or other services that the cable service provider designates for promotion to the user. The programming also may include a programming guide application that is configured to generate an integrated programming guide for the cable service provider content and OTT content.

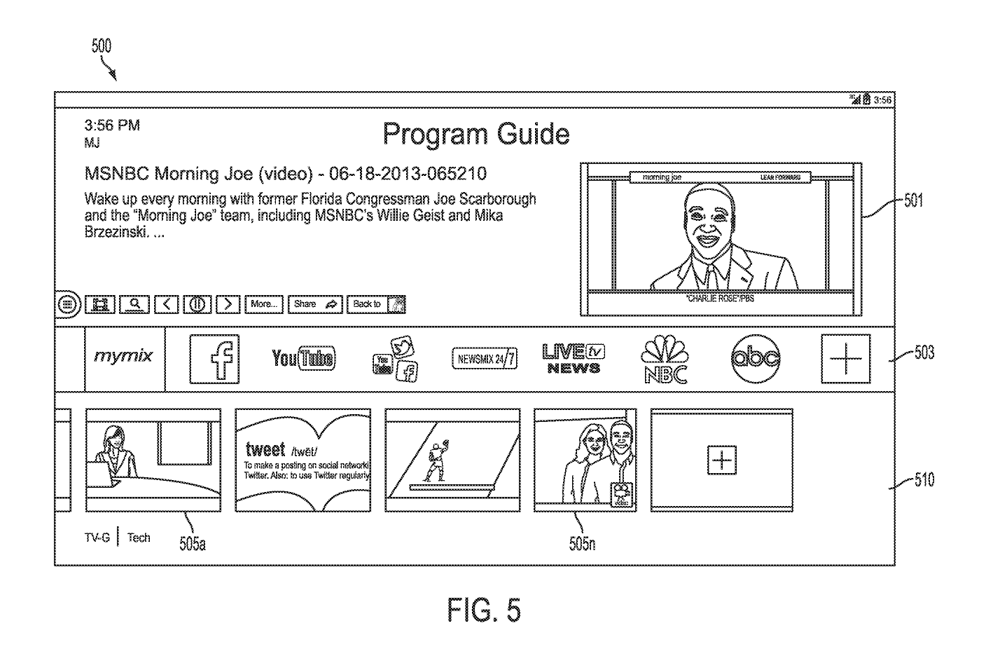

FIG. 5 illustrates an example of a unified programming guide interface 500 that the media player pass-through device may cause the display device to display to a user. A first portion of the interface is a media player 501 application that displays video corresponding to a channel to which the cable service provider set top box is set. Alternatively, the media player may display video from an OTT source that the user has selected. If the user changes the channel at the cable service provider set top box or selects another OTT source, then the media player 501 may update and display the video that is being transmitted on the newly-selected channel or received from the newly-selected OTT source, or a thumbnail or other fixed image or text corresponding to such content. A second portion of the interface will include a channel selector 503 that displays a set of channels that are available for the viewer to view. The channels will include broadcast and/or subscription-based channels from the cable service provider, as well as one or more channels from OTT sources, in a seamless format that does not require the user to change the interface other than to scroll or otherwise move among the channels. The available channels may correspond to a package of channels that the box retrieves from the cable service provider. As the user scrolls through the available channels, the programming guide interface will also include an asset listing interface 510 that displays a set of available content on a featured one of the available channels. The featured channel whose content is displayed in the asset listing interface 510 may correspond to the channel that is in a first position in the channel selector 503, at a different standard position, or to a position corresponding to a user selection. Each OTT content asset may be associated with metadata that includes an address of an OTT source where the content asset is available. When a user selects an asset from the asset listing interface, the media player device may use the address to identify the OTT source, and the box may retrieve the asset from the asset's corresponding OTT source or connect to an external media player that is available at the asset's corresponding, and the media player device may then cause the video asset to be displayed via the media player 501 application or in a full screen format.

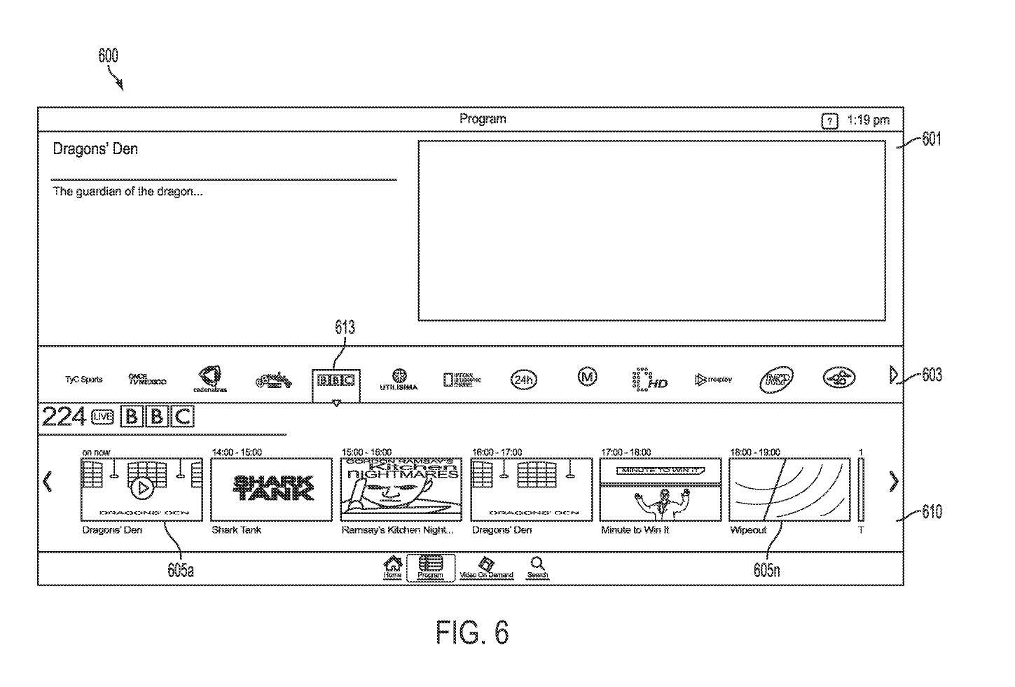

The example of FIG. 5 shows an example programming guide where the asset listing interface lists available on-demand assets 505a . . . 505n (i.e., videos) from a selected OTT source. FIG. 6 shows an embodiment of the programming guide interface 600 in which the user has selected a cable broadcast channel 613 from the channel selector 603. In this situation, when a user selects a channel 613, the asset listing interface 610 will display a menu of upcoming programs 605a . . . 605n on the selected channel in chronological order, optionally with start, stop and/or run length times. Optionally, in the asset listing interface 610, the menu listing for the program that is currently being broadcast on the selected channel may include a play input that a user may select to cause the program to be displayed via the media player 601 application or in a full screen format.

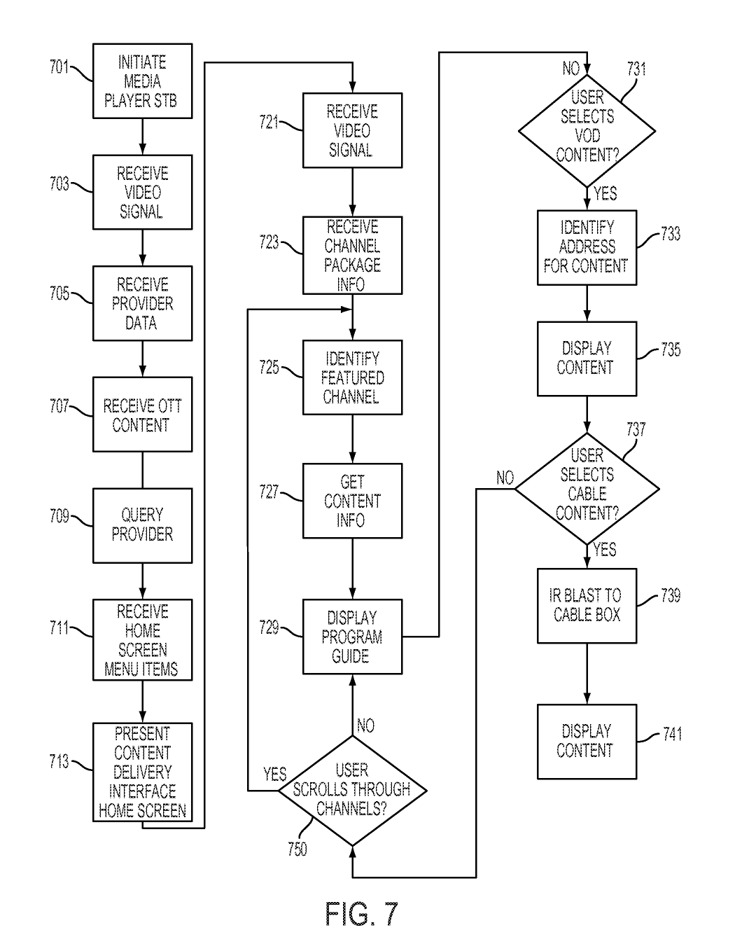

FIG. 7 is a flowchart illustrating various steps that the media player pass-through device may implement as it executes programming that is installed on the device or retrieved from an external source. The method may start when a user powers on, resets or otherwise initiates the media player device (step 701). Through a first interface, the media player device may receive video signals from an attached or wirelessly connected cable service provider set stop box (step 703) such as a digital video record (DVR). Through one or more additional wired or wireless interfaces to the Internet or another external data communications network, the media player pass-through device may receive data signals from a server of the cable television service provider (step 705), as well as data signals from various over-the-top video sources (step 707) such as websites not affiliated with the cable television service provider.

Based on data received from the provider's set top box and the provider's server, the media player pass-through device may execute and transmit, through an output port, instructional signals that cause a connected display to present a content delivery interface. The initial screen appearing on the display (step 713) may be a home screen that displays video corresponding to the video signal, and a menu of available over-the-top video content sources. The home screen may be a unified display wherein video corresponding to the video signal is displayed in a background on the display device, and wherein the menu of available over-the-top video content sources is displayed in a foreground on the display device so that the menu obscures at least a portion of the video being displayed in the background, such as is shown in FIG. 4.

To create the home screen, the media player device may transmit a query to the provider server 709 that includes identifying information relating to the user, such as a user identifier, a media player device identifier, or some other token that uniquely identifies the user and/or the media player device. The provider server may use this information to identify a user or device profile and return information corresponding to a package of channels and/or other services for which the user (or device) is a registered user. The package may include cable service provider channels, such as broadcast, cable and/or premium television channels. The package also may include OTT services for which the user or device is a registered user, such as a social networking site, a video-on-demand website or other service, a music subscription website or service. The package also may include free OTT services for which the user is not registered, or for which no registration is required, but which the subscriber and/or provider have opted to include in the package. The system may return to the media player pass-through device a set of menu items to be displayed on the home screen (step 711). The menu items may include icons for apps that are associated with at least some OTT services for which the subscriber is a registered user, and an icon for a unified programming guide that, when selected by the user, will display a menu of a set of cable television channels to which the subscriber subscribes along with a set of OTT services that serve video.

When a user selects the unified programming guide, or as an alternative to the home screen, the media player pass-through device also may cause the display to present an integrated programming guide screen 729 for the cable content and OTT content. To present the integrated programming guide screen, the media player pass-through device may receive and pass to the display a first video signal corresponding to a channel to which a cable television service provider set top box is set (step 721). This display may occur in a media player section of the programming guide screen.

The media player pass-through device also may receive, from the provider's server, data corresponding to a set of channels that are included in a package with which the pass-through device is associated, such as through a subscription (step 723). The package of channels will include traditional broadcast and/or cable video channels supplied by the cable television service provider and channels for OTT video services that are not affiliated with the cable television service provider. The system will display at least a subset of the channels in a channel selector portion of the programming guide screen. For each OTT source, the data may include an address associated with a media player application or video stream where the OTT source serves videos for viewing by consumers.

At least one of the displayed channels may be considered to be a featured channel (step 725). The featured channel may be the one that appears first in a list of channels, one that the user selects, or one that is otherwise highlighted on the screen. The featured channel may change as the user scrolls through a menu of channel and/or selects various channels. The media player device will retrieve, from the provider or the OTT source, information relating to a set of video content that is available on the featured channel (step 727), and it will display information relating to that content in an asset listing interface on the programming guide screen. If the featured channel is a cable television channel, then the media player pass-through device may retrieve a list of upcoming programs on the featured channel, either via the provider's set top box or via the provider's data server. The media player pass-through device may then cause the program guide to include the information corresponding to the upcoming programs in the menu of video content, so that the upcoming programs are displayed in chronological order and the displayed information includes a start time for each upcoming program. If the featured channel corresponds to an OTT video source, then the media player pass-through device may retrieve a list of available video-on-demand programs on the featured channel from the OTT source or from the provider server, and it may cause and the program guide to display information corresponding to the available video-on-demand programs in the menu of video content.

If the pass-through device receives a user command that is a selection of one of the available video-on-demand programs from an OTT source (step 731), then it may extract, from the data received via the communications network, an address for an OTT video service for the user-selected available video program (step 733). It may cause the display to present the user-selected video-on-demand program as served by the OTT video service at the address (step 735). In this way, the cable television service provider does not need to transmit, copy, share, or otherwise process the OTT content. Rather, the user's display displays the video to the user while it is served by and/or streamed from the OTT source itself.

If the pass-through device receives a user command that is a selection of one of the available cable channels (step 737), then it may generate a channel change command signal that is transmitted to the cable provider's set-top box. For example the channel change command may be transmitted by an IR blaster that is connected to the pass-through device (step 739) and which is in a transmission/reception range of the provider's set top box. The provider's set top box may then execute the command and return to the pass-through device a video signal corresponding to the requested channel. The pass-through device will relay that video signal to the display so that the display then displays video signal from the channel that is associated with the channel change command.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A system for providing video content to a subscriber, comprising:
a media player device comprising:
a first input interface configured to receive a video signal from a cable television service provider;
a second input interface configured to provide a connection to a communication network on which a plurality of over-the-top content items are available from a plurality of over-the-top video sources not affiliated with the cable television service provider;
an output port configured to deliver the video signal and a set of the over-the-top content items to a display device;
a processor; and
a non-transitory computer-readable medium containing programming instructions that, when executed, cause the processor to output a content delivery interface at the display device, wherein the content delivery interface comprises a home screen that displays:
video corresponding to the video signal, and
a menu of applications, a subset of which corresponds to available over-the-top video content sources.

2. The system of claim 1, further comprising:
the display device; and
a cable television service provider set top box configured to provide the video signal to the media player device.

3. The system of claim 2, further comprising a remote control that is programmed to control the display device and the media player device.

4. The system of claim 1, wherein the programming instructions that cause the processor to output the content delivery interface comprise instructions to implement the home screen as a unified display wherein:
video corresponding to the video signal is displayed in a background on the display device; and
the menu of applications is displayed in a foreground on the display device so that the menu obscures at least a portion of the video being displayed in the background.

5. The system of claim 1, wherein the programming instructions that cause the processor to output the content delivery interface to include the menu of applications comprise instructions to:
send a query and an identifier to the cable television service provider via the communication network;
in response to the query, receive from the cable television service provider a set of menu items that include a plurality of over-the-top video sources, at least a portion of which are sources for which a user associated with the identifier is a registered user; and
cause the menu to include:
icons corresponding the set of menu items, and
an icon for a unified programming guide that, when selected by the user, will display a menu of a set of cable television channels to which the user subscribes along with a set of over-the-top video sources designated by the cable television service provider and for which the user is a registered user.

6. The system of claim 1, wherein the programming instructions are also configured to cause the content delivery interface to present an integrated programming guide screen for the video signal and content items from over-the-top content sources by:
receiving, via the first input interface, a first video signal corresponding to a channel to which a cable television service provider set top box is set;
displaying video corresponding to the first video signal in a media player section of the programming guide screen;
receiving, via the second input interface, data corresponding to a set of channels that are included in a package to which a user of the media player device subscribes, the channels including broadcast channels supplied by the cable television service provider and channels for over-the-top video sources that are not affiliated with the cable television service provider;
displaying at least a subset of the channels in a channel selector portion of the programming guide screen;
identifying one of the displayed channels as a featured channel; and
displaying a menu of video content that is available on the featured channel in an asset listing interface on the programming guide screen.

7. The system of claim 6, wherein, if the featured channel is a cable television channel, the programming instructions that are configured to cause the content delivery interface to present the menu of video content for the featured channel comprise instructions to:
retrieve a list of upcoming programs on the featured channel; and
display information corresponding to the upcoming programs in the menu of video content, so that the upcoming programs are displayed in chronological order and the displayed information includes a start time for each upcoming program.

8. The system of claim 6, wherein, if the featured channel corresponds to an over-the-top video source, the programming instructions that are configured to cause the content delivery interface to present the menu of video content for the featured channel comprise instructions to:
retrieve a list of available video-on-demand programs on the featured channel;
display information corresponding to the available video-on-demand programs in the menu of video content;
receive a user selection of one of the available video-on-demand programs;
extract, from the data received via the second input interface, an address for an over-the-top video service for the user-selected available video program; and
cause the display device to present the user-selected video-on-demand program as served by the over-the-top video service.

9. The system of claim 2, wherein the media device further comprises an additional output port, and the system further comprises:
a transmitter connected to the additional output port; and
additional programming instructions that, when executed, cause the processor to:
determine when a channel change command is received from a remote control device; and
in response to the channel change command, generate a signal that, when transmitted via the transmitter to the cable television service provider set top box, will cause the cable television service provider set top box to implement the channel change command so that the video signal thereafter corresponds to a channel associated with the command.

10. A method of providing video content to a subscriber, the method comprising:
by a media player device having a processor, a first input interface, a second input interface and an output port:
receiving, via the first input interface, a video signal from a cable television service provider;
receiving, via the second interface and a data communication network, data signals from the cable television service provider, and also data signals from a plurality of over-the-top video sources not affiliated with the cable television service provider;
sending, via the output port, a signal that causes a display device to present a content delivery interface comprising a home screen that displays:
video corresponding to the video signal, and
a menu of applications, a subset of which corresponds to a group of the over-the-top video content sources.

11. The method of claim 10, further comprising, by the media player device, causing the content delivery interface to present the home screen as a unified display wherein:
video corresponding to the video signal is displayed in a background on the display device; and
the menu of applications is displayed in a foreground on the display device so that the menu obscures at least a portion of the video being displayed in the background.

12. The method of claim 10, wherein causing the content delivery interface to include the menu of applications comprises, by the media player device:
sending a query and an identifier to the cable television service provider via the data communication network;
in response to the query, receiving from the cable television service provider a set of menu items that include the group of over-the-top video content sources, at least a portion of which are sources for which a user associated with the identifier is a registered user; and
causing the menu to include:
icons corresponding the set of menu items, and
an icon for a unified programming guide that, when selected by the user, will display a menu of a set of cable television channels to which the user subscribes along with the group set of over-the-top video sources.

13. The method of claim 10, further comprising, by the media player device, causing the content delivery interface to include an integrated programming guide screen for the video signal and the videos from the group of over-the-top video content sources by:
receiving, via the first input interface, a first video signal corresponding to a channel to which a cable television service provider set top box is set;
displaying video corresponding to the first video signal in a media player section of the programming guide screen;
receiving, via the second interface, data corresponding to a set of channels that are included in a package to which a user of the media player device subscribes, the channels including broadcast channels supplied by the cable television service provider and channels for over-the-top video sources that are not affiliated with the cable television service provider;
displaying at least a subset of the channels in a channel selector portion of the programming guide screen;
identifying one of the displayed channels as a featured channel
displaying a menu of video content that is available on the featured channel in an asset listing interface on the programming guide screen.

14. The method of claim 13, wherein, if the featured channel is a cable television channel, then causing the content delivery interface to present the menu of video content for the featured channel comprises:
retrieving a list of upcoming programs on the featured channel; and
displaying information corresponding to the upcoming programs in the menu of video content so that the upcoming programs are displayed in chronological order and the displayed information includes a start time for each upcoming program.

15. The method of claim 13, wherein, if the featured channel corresponds to an over-the-top video source, then causing the content delivery interface to present the menu of video content for the featured channel comprises:
retrieving a list of available video-on-demand programs on the featured channel;
displaying information corresponding to the available video-on-demand programs in the menu of video content;
receiving a user selection of one of the available video-on-demand programs;
extracting, from the data received via the second input interface, an address for an over-the-top video service for the user-selected video-on-demand program; and
causing the display device to present the user-selected video-on-demand program as served by the over-the-top video service.

16. The method of claim 10, further comprising, by the media player device:
receiving a channel change command;
in response to the channel change command, generating a channel change signal that, when transmitted via a transmitter to a cable television service provider set top box, will cause the cable television service provider set top box to implement the channel change command so that the video signal thereafter corresponds to a channel associated with the command; and
sending the signal to the transmitter.

17. A method of providing video content to a subscriber, the method comprising:
by a media player device comprising a processor, a first input interface, a second input interface and an output port:
receiving, via the first input interface, a video signal from a cable television service provider;
receiving, via the second input interface and a data communication network, data signals from the cable television service provider, and also data signals from a plurality of over-the-top video sources not affiliated with the cable television service provider;
sending, via the output port, a signal that causes a display device to present a content delivery interface comprising a unified programming guide screen that displays:
video corresponding to the video signal in a media player section of the programming guide screen, and
a channel selector containing identifying information for set of channels, the channels including broadcast channels supplied by the cable television service provider and channels for a group of the over-the-top video sources that are not affiliated with the cable television service provider.

18. The method of claim 17, further comprising, by the media player device:
identifying one of the channels in the set as a featured channel; and
presenting a menu of video content that is available on a featured channel in an asset listing interface on the programming guide screen.

19. The method of claim 17, wherein, if the featured channel is a cable television channel, then the presenting the menu of video content for the featured channel comprises:
retrieving a list of upcoming programs on the featured channel; and
displaying information corresponding to the upcoming programs in the menu of video content, so that the upcoming programs are displayed in chronological order and the displayed information includes a start time for each upcoming program.

20. The method of claim 17, wherein, if the featured channel corresponds to an over-the-top video source, then the presenting the menu of video content for the featured channel comprises:
retrieving a list of available video-on-demand programs on the featured channel;
displaying information corresponding to the available video-on-demand programs in the menu of video content;
receiving a user selection of one of the available video-on-demand programs;
extracting, from the data received via the second input interface, an address for an over-the-top video service for the user-selected video-on-demand program; and
causing the display device to present the user-selected video-on-demand program as served by the over-the-top video service.
